(19) United States
(12) Patent Application Publication
(10) Pub. No.: US 2022/0088522 A1
(43) Pub. Date: Mar. 24, 2022

(54) Dust and debris filtration system for cleaning air used in the conveyance of granular material to and from the silo, dry bulk trailer, rail car, and other transportation and conveying means

(71) Applicants: David E. Sisk, Park Hills, MO (US); Peter Kemp, Crestwood, MO (US)

(72) Inventors: David E. Sisk, Park Hills, MO (US); Peter Kemp, Crestwood, MO (US)

(21) Appl. No.: 17/300,841

(22) Filed: Nov. 22, 2021

Related U.S. Application Data
(63) Continuation-in-part of application No. 16/873,236, filed on Mar. 2, 2020.
(60) Provisional application No. 63/205,345, filed on Dec. 3, 2020.
(60) Provisional application No. 62/919,379, filed on Mar. 7, 2019.

(51) Int. Cl. B01D 46/00; B01D 46/24; B01D 46/58; B01D 46/48; B01D 46/42

(52) U.S. Cl. CPC B01D 46/0046; B01D 46/24; B01D 46/58; B01D 2265/027; B01D 46/4272; B01D 46/0002; B01D 2273/28; B01D 46/48

(57) ABSTRACT

A dust filtering and collection system for filtering dust and other particles from an incoming air stream generally used for conveying granular material, the filtering system receives the air from within the tank trailer, pre-separates the heavy dust particles and other debris at the bottom of a filter housing, without its impingement upon the filter tube(s) contained upwardly therein, and then passes the partially filtered air upwardly through filter tube(s) for purifying the air before discharge to atmosphere. The filter housing for the system includes a cylindrical housing upwardly, an integral cone shaped housing at its bottom, into which the dust particles settle, it has a transverse plate at its upper segment, which supports the filter tube(s), an air inlet being centrifugally and integrally formed at the bottom of the cylindrical member of the filtration system.

### CROSS-REFERENCE TO RELATED APPLICATION

This application claims the benefit of U.S. Provisional Application No. 63/205,346, filed Dec. 3, 2020, the entirety of which is hereby incorporated by reference. This application is a continuation-in-part of U.S. patent application Ser. No. 16/873,236, filed on Mar. 2, 2020, which claims the benefit of U.S. Provisional Application No. 62/919,379, filed Mar. 7, 2019, the entireties of which are hereby incorporated by reference.

### FIELD OF THE INVENTION

This invention relates to the efficiency in the operations of a spin flow inlet/outlet filtering means used in conjunction with bulk granular material conveying vehicles to more effectively separate the air conveying grain material from dust and other particles or debris when conveying such materials to and from such vehicles or their storage silo, during operations of the system. The invention is primarily concerned with the structure of a filtration housing, incorporating filtration means within its structure, wherein the incoming air, to be filtered, is oriented in a direction that provides for greater efficiency in the separation of dust and other debris from the conveyed air, before passing it through the arranged filter, providing for the cleansing of the air that was used in the conveyance such granular material, such as grains, that may be included as ingredients within food products, or the like, at the site of its processing and usage.

### BACKGROUND OF THE INVENTION

The present invention relates to a dust filtering and collection system, and the structure that is embodied within the filtration device, including achieving efficiency and separation of dust and debris from the air being filtered after conveyance from its source. More specifically, in the dry bulk conveyance of granular material, such as grains, where various suction lines and vacuums are generated to provide for the conveyance of such granular materials, such as grains, to and from a silo, tank trailer, railroad car, and other dry bulk trailers, it is essential to remove dust from the granular product from the air before it passes through the blower and damages said blower. During the process of pneumatically conveying the air that is used to convey granular material, the air picks up dust from the material. The dust is an inhalation hazard and explosion hazard and must be removed from the air for safety prior to venting the air. The present invention relates to such dust filtering and collection systems, and more particularly, to a dust filtering and collection system for use in mobile vacuum loading/unloading vehicles, or other industrial environments, into a dust filtering system employing efficiency of the orientation of structures in the housing for the filtering device, so that the incoming contaminated air can unobstructively employ gravity to provide for initial separation of heavier dust and debris from the air to be processed and filtered, the air having been used in the conveyance of the grains, either into or out of the vehicle storage tank trailer. In addition, the filtration means employed provides for very fine separation of further dust particles, from the air, to sanitize the latter, and further incorporates a closing structure, at its lid position, in the form of sealed manhole clamps, that allows for rapid opening and closing of the filter housing, for clean out, and servicing, or replacement of the filtering means.

Heretofore, the inventors herein have obtained earlier patents upon the means for the cleansing of the conveying air to be used in conveying of food grade and related granular bulk materials, and such can be seen in the U.S. Pat. No. 5,053,063, upon the dust filtering and collection system, as noted therein. This shows the overall assembly of the various structures making up the storage tank of the dry bulk trailer, including its elongated storage tank, the dust filtering and collection canister associated therewith, and its filtration tubes provided within the canister, in addition to the flow paths for the various air lines that provide for conduct of the dust laden air stream from the canister, to the filtration device, and the other flow lines associated with the conveyance of the purified air to the primary discharge line that uses pressurized air to convey the granular material for unloading from the tank trailer, to the site of its usage or storage. That disclosure provided an overall analysis of the bulk tank vehicle storage tank, its various air conveying lines, and a filtration device used therein, during its processing of granular material. As can be seen in said patent, the incoming air was directed directly into its filtering tubes, which did not provide for a prestaging of separation of dust and other debris from the said incoming air, before such air was conveyed directly to the filtration tubes for further processing. Hence, clogging of the filtering means prevailed due to the lack of pre-separation of the heavier dust particles from with incoming air, before being filtered.

The United States patent to one of the inventors herein, U.S. Pat. No. 8,657,898, also depicts an air filter spin flow inlet/outlet housing, which shows a separate type of structure for filtering of the air used in the conveying of bulk granular materials from a tank trailer, such as the type that also uses air pressure to achieve granular flow, and its distinct air filtration unit incorporating an intake that induces its spiral flow, upon entering of its associated filtering device.

The concept of the current invention is to provide for restructuring of the air filtration system of a bulk tank granular material conveying system, such as a bulk tank trailer, that more efficiently pre-cleanses the air from the tank trailer, laden with such granular type grain materials, so as to reduce the pressure upon the filtering device, and lessen its incidence of clogging or premature deterioration, by providing for a pre-separation of dust, and other debris, from such air to be treated, and cleansed by the filter of the current invention. Secondly, the structure of this invention incorporates a sealed manhole clamping device at its end opposite from the air inlet, that provides for a very quick opening of the filtration system, and its housing, to provide for access therein, when it may be necessary to properly service the filtration device, for immediate further usage in the conveyance of such materials.

These are examples of prior art known to the Applicants of these improvements.

### SUMMARY OF THE INVENTION

Among the several objects and advantages of the present invention may be noted.

Initially, the concept of the invention is to conveniently orient the processing of the incoming air to a filtering structure, within a bulk tank granular material conveying vehicle, so as to provide for an additional pre-separation of the air, from its dust particles and debris, before the air is induced to enter into the filter structure, to provide for its thorough cleansing before discharge to the surrounding environment.

The specific structure for achieving the results as just stated includes the orientation of the dusty incoming air within an air inlet that is oriented at an approximate 10° negative angle relative to the horizontal of the filter housing into which the air is conveyed, in order to achieve a pre-separation of the bulk of its conveyed dust, and other debris, that may be embodied within the dust laden incoming air that is to be processed by the filtration means operative associated with the filter housing of this invention. Obviously, such angular orientation of the air inlet may be as low as approximately 5°, or as high as 15°, depending upon the specific gravity of the incoming air gauged by the type of granular material being conveyed, during usage of this filtering device within the bulk transfer system disclosed within this invention. Also, the speed of the incoming air between about 2 cfs to around 20 cfs, regulate the separation of the heavier degrees and dust from the incoming dust ladened air. Secondly, downwardly from the dusty air inlet is a cone shaped section designed to collect the separated dust and other particles, from the air, before the air is forced upwardly and attracted into the filtration system due to the operations of a blower, that communicates with the suction line of the trailer granular material conveying system during its operations. In addition, in summarizing the assembly of this development, the incoming air through the air inlet is oriented for centrifugal movement around the lower housing, and down towards its defined conical section, and away from the filter tubes arranged there above, so that some of the dust and the large particles fall out of the airstream, and are deposited within the bottom of the lower cone section, before the remaining air is sucked upwardly and pulled through the filtration system of this associated filter housing to remove any remaining fine dust particles. In addition, the concept of this invention is to utilize a manhole clamp type of closure, at the top of the filter housing, up where the air outlet exits from the housing, after its air filtration, so that the lid structure can be very promptly opened and removed, for access to the filter structure, within the housing, as may be required for its clean out and prompt servicing as may be required.

The structure of this spin flow vacuum filter device is conveniently integrated into the overall granular material conveying system, whether it be one that is associated with a tank trailer, receiving such material as vacuumed from a storage silo, or where the bulk trailer may receive such material from a railroad car, or other dry bulk trailer type arrangement, that are normally used and employed for the conveyance of food grade or other industrial granular material, during transport.

Thus, the position of this invention, comprising the aforementioned dust filtering and collection system, is designed to collect the dust particles as accumulated product particles within the canister or chamber, and then return the accumulated product particles to a collection area, for removal. Thus, the filter arranged thereabove from the circularly oriented air inlet is designed to capture any remaining residue dust, oil, even rust particles, and other contaminants from the blower system, that is generally used for assisting in the unloading of the granular material from a storage bin, and also to provide for the transfer of such material from the bulk tank trailer, when it reaches its destination. Cleanliness of such air prior to its venting to the environment is paramount, particularly, as previously reviewed, when the bulk material can impart dust to the air which, without filtering, poses an inhalation risk or explosion risk when vented to the environment.

It is, thus, the principal object of this invention to provide a pre-separation of dust and other particles from the air that is used to convey granular material during its transit, storage, or when unloaded from the tank trailer or railroad car, when they reach their destination.

Another object of this invention is to provide a planned angular orientation of the incoming air, into the filtration system, at a negative angle, below the filtering means itself, so as to provide for that pre-separation of particles, before the remaining air is attracted or vacuumed upwardly into the filtering system, during its processing in preparation for facilitating the transfer of the bulk granular material in recycling it for its usage or storage.

Another object of this invention is to provide for a negative angle orientation of the dusty air inlet, into the filtration system, to provide for that pre-separation of any heavier dust particles, or other deleterious particles, from the air, before it is subject to the filtering structure of the associated system.

A further object of this invention is to provide for a manhole type of closure for the top of the filter housing, that may be conveniently and promptly opened, for servicing of the filtration system, and promptly closed, after completion of its servicing. As known in this field, time is of the essence in the handling and processing of granular bulk materials, through the use of tank trailers, that travel our highway system.

These and other objects may become more apparent to those skilled in the art upon review of the Summary of Invention as provided herein, and upon taking a study of the Description of Its Preferred Embodiment, in view of the drawings.

### BRIEF DESCRIPTION OF THE DRAWINGS

In referring to the drawings:

FIG. 1 discloses the spin flow vacuum filter of this invention as embodied within the system for conveying and processing of granular material, incorporating, in this instance, a dry bulk tank trailer, incorporating the various dusty and clean air conduits, for use for conveying of granular materials;

FIG. 2 is a front view of the spin flow vacuum filter of this invention;

FIG. 2a is a side view of the spin flow vacuum filter of this invention;

FIG. 2b is an isometric view of the spin flow vacuum filter of this invention;

FIG. 2c is a top view showing the manhole type clamping of the closure onto the spin flow vacuum filter of this invention;

FIG. 3 is a sectional view of the spin flow vacuum filter taken along the line A-A of FIG. 2;

FIG. 3a is a longitudinal sectional view taken on the line B-B of FIG. 2c; and

FIG. 3b is a longitudinal sectional view taken along the line C-C of the spin flow vacuum filter of FIG. 2c;

FIG. 4 shows the filter tube holding grommet that secures the individual filter tubes in place, within the transverse panel of the filtration system;

FIG. 4a is a top view of the grommet, showing holding one of the filtration tubes securely in place;

FIG. 4b is a sectional view of the grommet, holding a filtration tube, taken along the line J-J of FIG. 4; and

FIG. 4c shows a sectional view of the grommet, within the transverse panel, and holding a filtration tube securely in place, taken along the line H-H of FIG. 4a.

### DESCRIPTION OF THE PREFERRED EMBODIMENT

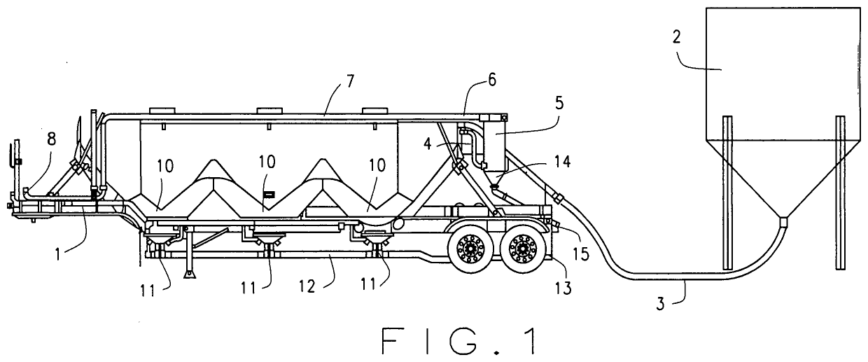

The overall concept of this invention, and the various improvements that it makes to the filtration of the air that is used to motivate the transfer of granular material from various storage spaces, to a tank trailer, railroad car, or the like, and the processing of that air flow in order to keep it clean, reduced of any impurities and dust, picked up from the conveyance of such materials, can generally be seem in the system as noted in FIG. 1. As can be seen, the tank trailer, in this instance, as noted at 1, is generally provided, for receiving the granular material from a storage silo, as noted at 2. A conveying line 3 is subject to vacuum pressure in order to move material from the silo to and into the dry bulk trailer of the tank trailer 1. This is generally when the silo, for example, may be laden with wheat, corn, or any other type of construction granular material, at a plant, and such materials are to be conveyed, and transferred, by means of the tank trailer 1, to elsewhere, as can be understood. As the tank trailer is being filled with such material, within its bins the dusty air moving the material and laden with other debris eventually is contained within the tank trailer, since that vacuuming air transfers such materials from the silo into the dry bulk trailer, as noted. Then, that dusty air is conveyed by the air line 4 and into the filtration system 5 of this invention, where such air is to be treated, for the elimination of any deleterious particles, and any heavy components of the dusty air, to provide for separation from the vacuuming air, with the remainder of the pre-filtered air passing through the filtration system 5, through its filters, to be subsequently defined, and passing by way of a blower, as at 6, through the clean air line 7 transferring the air from the filter, to the air line 8 which is connected with a blower that draws the clean air from the filtration system, by means of its connected suction line (not shown). At that point, the blower may be initiated for passing air under pressure through the air conveying line 9, and beneath the various contoured conically shaped bottom segments, as at 10, of the various storage sections of the tank trailer 1, as can be noted. When the valves, such as the butterfly valves 11 are either manually or automatically opened, the air passing through the air line 9, communicating with the conveying line 12, empties the tank trailer for deposit of its granular material out of its ports 13 for transfer to the site of its usage or further storage. In some embodiments, the filtration system 5 is not used during such unloading process. The dust generated during loading process can be collected and then discharged to the bin if desired. The filtration system 5 includes a downwardly disposed conical segment 14 for deposit of its collected dust and debris to a collection port 15, for dispensing, or for other usage, separate from the conveyed granular material that exits the port 13, as can be understood.

As can be seen from the overall system, it is the vacuuming air under pressure that is used to load the dry bulk trailer, in this instance, from the stored silo 2. The blower is connected to its suction line, and vacuums product into the trailer from its associated silo, railcar, or other dry bulk trailer that may be transferring such granular material. The vacuum filter within the filter system 5 protects the blower from product backing up into the blower and causing blower failure. In addition, the filter within the filtration system prevents the venting of dust, to the atmosphere, which may be undesirable, and violate regulations.

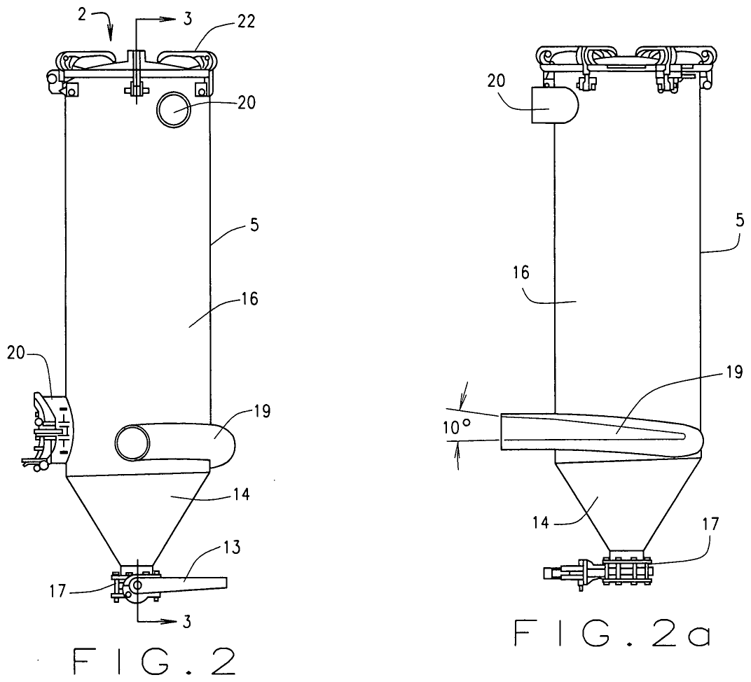

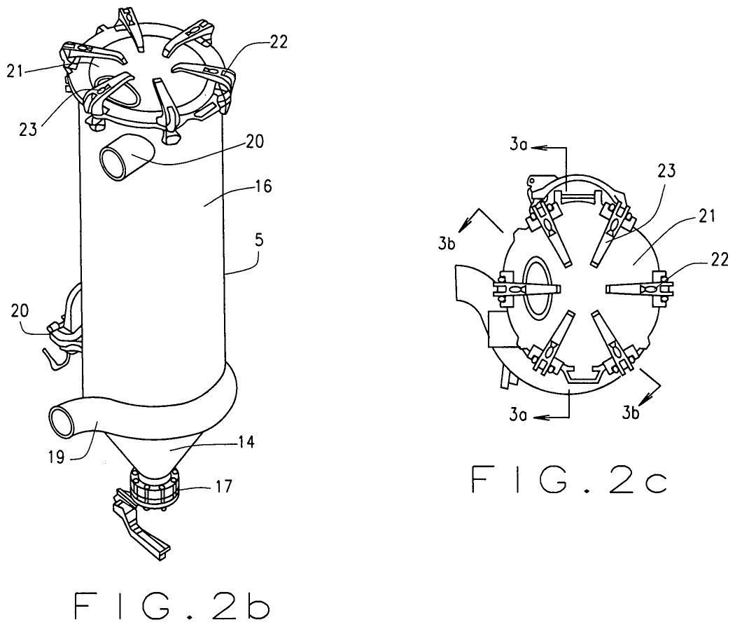

As can be generally seen in FIGS. 2-2c, the filtration system 5 includes a housing 16, which contains the filtration elements, as will be subsequently defined, and the housing has a generally cylindrical shaped section, as noted at 16, and integrally is formed having a downward sloping conically shaped section 14, as previously defined, and into which the various dust particles and debris deposit, and which can be removed by the opening of its valve 17 either manually, or automatically, through shifting of its handle 18, and transfer out of the dust collection port 15, for disposal, as previously described. What is to be noted, to attain the beneficial results through usage of this invention, is that the dusty air inlet, as noted at 19, enters into the approximate bottom of the cylindrical segment 16 of the filter housing, and as can be noted, such orientation of the air inlet is at an angle, principally at a negative angle, relative to the horizontal of the filter system 5, so that the air enters in a downward motion, cylindrically applied in a cyclone type fashion in order to circulate the dusty air at this location, near the bottom of the filter housing, and as will be subsequently described, below the lower edges of the filter device contained within the housing 16, for reasons as previously summarized, and to be explained herein.

Heretofore, where cyclone type filters were used to filter dust particles from flowing air, when it entered into the filtration housing, it would impinge upon the lower edges of the filter elements, and because of the pressure of that flowing air, would eventually accelerate the deteriation of the lower segments of such filters, and prevent their adequate functioning. In this instance, where the circulating air enters in a downward flow, as previously noted at approximately a 10° angle, that dusty air is below the contained filtration structure, and does not impinge upon its bottom edges, as can be understood.

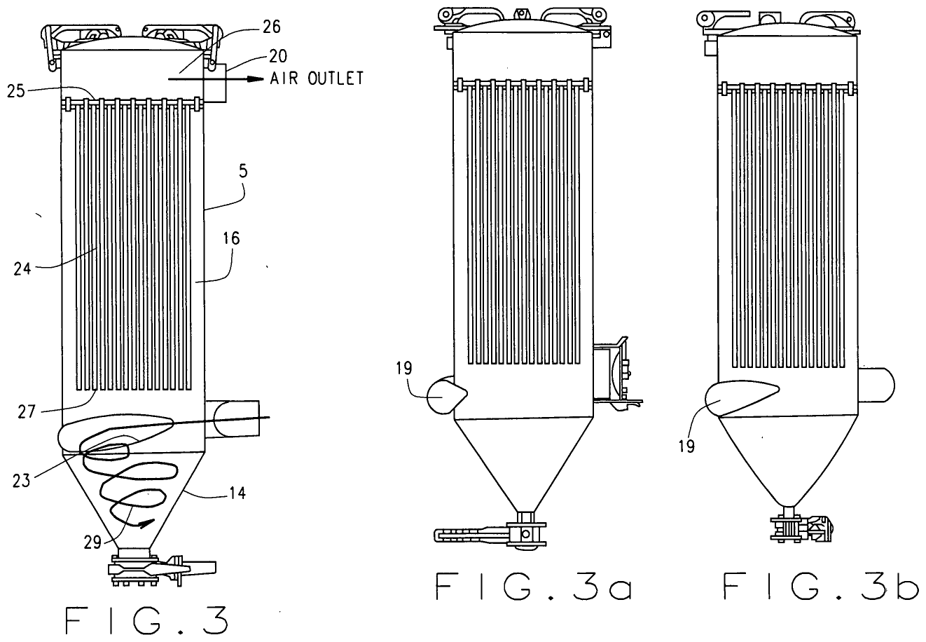

This will be described in greater detail in the description of the filter elements in FIG. 3.

Furthermore, once the filtered air passes through the filter housing 16, that air exits its clean air outlet 20 and transfers to the air conveying line 6, as previously reviewed.

As can also be seen, as noted in FIG. 2b, the dusty air inlet 19 wraps around a portion of the lower housing segment of the cylindrical filter 16, in order to provide for a spiral flow of the incoming air, to achieve the purposes of dust and debris pre-separation, as the air enters in that spiral flow motion, at the bottom of the filter device.

As also noted, it can be seen that there is an access port, as at 20, which when its cover is opened, allows for access into the filter system 5, as can be understood.

As also noted, the upper closure 21 is provided with a series of manhole type clamps 22 around is periphery, and these can be conveniently opened by pulling up their accompanying levers 23, to allow for quick removal of its closure, and access into the filtration system, when servicing is required. And, the cover can be very quickly reinstalled, and closure of its cam levers 23, once such servicing has been completed.

Within the filtration system 5, and its housing 16, is the filtering device 24 as noted. In this instance, it includes a series of cylindrical tubes, as noted, which at their upper ends are supported by a transverse panel 25, so that opened upper ends of such tubes allow for the clean air passing through such filter tubes to enter into the air outlet chamber 26 and out the air outlet 20 as previously reviewed. The bottom of these tubes 24 are sealed closed, either by crimping, or molded closed, as at 27, so that the dusty air that surrounds the tubes migrates through the porous tubes, and into their interiors, for filtration of the remaining residue dust particles, so that it is only clean air that enters into the outlet chamber 26, as can be understood.

Even though the filtration devices, comprising the plurality of tubes as noted at 24 in FIG. 3, may be shown as a multitude of such tubes, similar to what was previously shown in our U.S. Pat. No. 5,053,063, it is just as likely that much lesser numbers of tubes, or perhaps even a singular wide tube, such as shown in U.S. Pat. No. 8,657,898, could be used for the filtration purposes. These types of tubes may be formed to provide for fine filtration of miniscule particles, one that may be made of porous polyethylene, or even of Teflon, and which are formed having very fine porosity, so as to prevent the passage of dust particles, but allows for the air to move into such filtration tubes, as it is cleansed, for further collection and transfer out of the air outlet, such as the outlet 20, as previously described. Furthermore, such tubes may be made from a polymer, such as polyethylene, or Teflon, with about a 40-50 micron porosity at the outer wall of the tubes, said may extend through tortuous paths to restrict the inner openings of about 2.5 microns, along the inner walls of the tubes, as can be understood. This provides for a very fine filtration of the remaining dust particles from the passing air, as it is thoroughly cleansed as it moves into the interior of such tubes, for passage upwardly out of the outlet chamber 26, as previously explained.

As can further be noted in these FIGS. 3-3b, where the dusty air inlet 19 wraps around the bottom area of the filter housing 16, there is an elongated opening, as noted at 28, that passes the air into the bottom of the filter housing 16, in a centrifugal motion of flow, in a downward direction, that allows for the air to spirally circulate, as noted at 29, and deposit its heavier dust particles, and any other debris, into the lower conical section 14 of the filtering system 5, as explained.

As noted, the incoming air at this location is directed around the housing and down towards the conical section and away from the filter tubes. The large particles fall out of the air stream and are deposited directly into the bottom of the formed cone or tapering segment. Furthermore, the inlet air does not impinge directly upon the bottom 27 of the filter tubes, and this does not allow for any of the heavier dust or other particles to impact against the lower segments of the filter tubes, since that material drops out of the incoming flowing air, below such filter tubes, during operations of this filtration device.

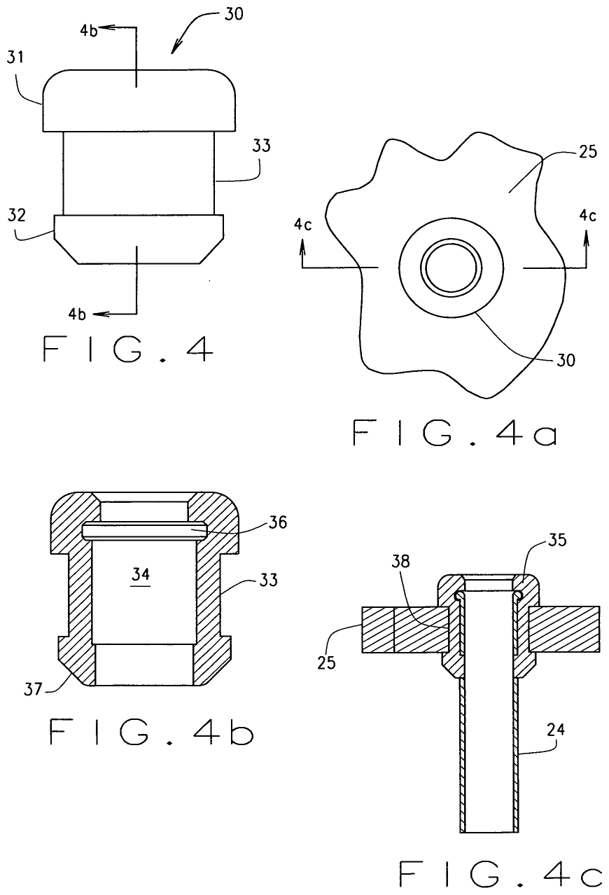

As can be noted in FIGS. 4-4c, therein is disclosed a grommet, as at 30, which is embraced and secured to the transverse panel or plate 25, as previously explained, and the grommet has a unique configuration for purposes to be subsequently described. As noted, the grommet is an integrally formed member, for holding individual filtration tubes, such as one shown at 24, and has an upper formed boss like member 31, a lower flanged member 32, and a recessed portion 33 as can be noted. Interiorly, as noted in FIG. 4b, there are a series of channels interconnected extending through the grommet, as can be noted at 34, and is it through these channels that the tube 24 inserts, when applied to its particular grommet. As noted, each tube has an upper integral flange-like portion 35, that snaps within an annular recess 36 which firmly holds the tube in place when assembled within its associated grommet, as can be understood, and as can be seen in said FIG. 4c. The bottom of the grommet, as at its lower flange 32 has a bevel, as noted at 37, and this facilitates the insertion of the grommet, supporting its tube 24, within the transverse supporting panel 25, when assembled.

The grommet is made of a resilient rubber, or polymer, such as a urethane, which has some degree of flexibility, so that it allows for the grommet, at its lower flange 37, to be forced through the associated aperture 38 of the transverse panel 25, when forced downwardly, until such time as the panel 25 inserts within the recess 33, as previously explained. The reason for this is as follows:

The incoming dust laden air that enters into the filtration system 5, as previously explained, may have some degree of pressure, that builds up, and could be anywhere within the range of 1 to 2 bar, when the system is fully operative, compacted with the dust laden air, and with that type of pressure, when the various porous outer walls of the tubes 24 may get compacted with dust, or larger dust particles, that do not pass through the tube, for obvious purposes, as in earlier filtration devices, pressure can build up on the tubes, and on occasion has forced them upwardly, out of their grommets, which inadvertently allows a lot of the dusty air to enter into the conveying system, which is just highly undesirable. Hence, when the transverse panel 25 snuggly fits within the recess 33, of the grommet, and is held in position in that manner, its tube 24 is thoroughly locked into position with the transverse panel, and the type of pressures that are generated within this filtration system, will not force the tubes to disengage from their grommets and the transverse panel, during routine operations of the dust and debris filtration system of this invention.

Thus, these retention features for these components as just described, adds to the efficiency and effectiveness of operations of this filtration system, during its routine usage in combination with a tank trailer, railroad car, or the like.

Variations or modifications to the subject matter of this invention may occur to those skilled in the art upon review of the development as provided herein. Such variations, if within the spirit of this invention, are intended to be encompassed within the scope of any claims to patent protection issuing hereon. The explanation of the invention in the Description of the Preferred Embodiment, and its depiction within the drawings, are generally set for illustrative purposes only.

We claim:

1. A dust filtering and collection system for use in a pneumatic loading/unloading system, such as a tank trailer, said system for use for moving product granular materials by way of a vacuum or pressure source to and from a storage chamber, comprising:
a dust filtering housing, said housing having an upper end that incorporates a closure member, the bottom end of said housing having a lower narrowing and tapering structure, and into which dust particles and other debris collect, the bottom of said tapering segment having a valve, which when opened, allows for dispensing of the collected dust particles;
a dust filtering system suspended within said filter housing, a transverse plate provided in the upper segment of said housing, said transverse plate with a closure member providing a clean air chamber and a clean air outlet, at least one filtration tube suspended from the transverse plate and extending partially downwardly into the filter housing, a clean air outlet provided for discharging clean filtered air from the filtration system, and provided extending from the clean air chamber, a dusty air inlet communicating with the bottom of the filtration housing, and disposed for passing dusty air into the air inlet in a centrifugal fashion and below the lower ends of the at least one filtration tube so that the incoming air does not impinge or impact upon the filtration tube at its lower end, to prevent impacting of the dust laden particles upon said filter tube, whereby through the filtration system air used in the conveying systems of a bulk tank trailer or other system for transport of such granular materials is cleaned for venting.

2. The dust filtering and collection system of claim 1, wherein there are a plurality of filtration tubes provided within the filter housing.

3. The dust filtering and collection system of claim 1, wherein the incoming dust laden air emanates from the storage bin of the bulk tank trailer or other system for transport of granular materials.

4. The dust filtering and collection system of claim 1, wherein the closure member at the top of the filtration housing includes a series of manhole clamps which may be manipulated between opening and closing to provide for prompt removal or replacement of the closure member during servicing of the said filtration system.

5. The air filtration and collection system of claim 4, wherein the locking devices for holding the closure member to the filtration housing comprises cam levers which when manipulated provide for sealed closure of the closure member against the top of the filtration housing.

6. The dust filtering and collection system of claim 1, wherein the dusty air inlet is tangentially structurally located relative to the filtration housing to thereby provide for a spin flow of air passing into the housing for filtration purposes.

7. The dust filtering collection system of claim 6, wherein the dusty air inlet is oriented at between an approximate 5° and approximate 15° negative angle relative to the horizontal of the filter housing into which the air is conveyed.

8. The air filtration and collection system of claim 1, wherein each filtration tube is secured within a grommet that engages the transverse plate so as to prevent any disengagement of the grommet, and its supported filtration tubes, when subjected to the high pressures of the dusty air entering into the filter housing of the filtering system.

9. The dust filtering and collection system of claim 7, wherein the grommet includes an annular recess, into which the transverse plate locates, for locking and holding each grommet, and its filtration tube in position during installation and operations of the filtering system of this invention.

10. A dust filtering and collection system for use in a pneumatic loading/unloading system, such as a tank trailer, said system for use for moving product granular materials by way of a vacuum or pressure source to and from a storage chamber, comprising:
a dust filtering housing, said housing having an upper end that incorporates a closure member and a bottom end into which dust particles and other debris collect, the bottom end having a valve, which when opened, allows for dispensing of the collected dust particles;
a dust filtering system suspended within said filter housing, a transverse plate provided in the upper segment of said housing, said transverse plate with a closure member providing a clean air chamber and a clean air outlet, at least one filtration tube suspended from the transverse plate and extending partially downwardly into the filter housing, a clean air outlet provided for discharging clean filtered air from the filtration system, said clean air outlet extending from the clean air chamber, a dusty air inlet communicating with the filtration housing, and disposed for passing dusty air into the filtration housing, whereby through the filtration system air used in the conveying systems of a bulk tank trailer or other system for transport of such granular materials is cleaned, wherein each filtration tube of the at least one filtration tube is secured within a grommet that engages the transverse plate so as to prevent any disengagement of the grommet, and its supported filtration tubes, when subjected to the high pressures of the dusty air entering into the filter housing of the filtering system, wherein the grommet includes an annular recess, into which the transverse plate locates, for locking and holding each grommet, and its filtration tube in position during installation and operations of the filtering system of this invention, and wherein each grommet includes a further annular recess positioned within the grommet into which an upper integral flange-like portion of one of said at least one filtration tube snaps to secure the at least one filtration tube to the grommet.
